(19) United States
(12) Patent Application Publication
(10) Pub. No.: US 2002/0161464 A1
(43) Pub. Date: Oct. 31, 2002

(54) Method and apparatus for creating personalized labels

(75) Inventor: Russell Weiner, New Rochelle, NY (US)

Correspondence Address: FITZPATRICK CELLA HARPER & SCINTO, 30 ROCKEFELLER PLAZA, NEW YORK, NY, 10112, US

(73) Assignee: PepsiCo, Inc., Purchase, NY

(21) Appl. No.: 10/121,729

(22) Filed: Apr. 15, 2002

Related U.S. Application Data
(60) Provisional application No. 60/283,359, filed on Apr. 13, 2001.

(51) Int. Cl. G06F 19/00

(52) U.S. Cl. 700/97

(57) ABSTRACT

A method allows a consumer to personalize a label for a product. The consumer performs the steps including inputting data into a workspace defined by software and obtaining a label comprising at least one of text and an image printed on a substrate. The software is adapted to generate personalized data comprising (a) at least one of text data and image data selected or created by a consumer and (b) location data that represent the location of the at least one of text data and image data in the workspace. The at least one of the text and image is printed in accordance with the personalized data. The consumer can then secure the label to the product.

This application claims the benefit of provisional U.S. Application No. 60/283,359 filed Apr. 13, 2001.

### FIELD OF THE INVENTION

The present invention relates to an apparatus and method wherein consumers can use a personal computer in order to design their own labels for a product, such as a canned or bottled beverage.

### BACKGROUND OF THE INVENTION

Societal trends are leaning more and more towards personalizing products. However, this has not yet been significantly translated to the food and beverage industries. While there is a proliferation of choices and flavors, consumers typically do not play an active role in designing the look of the containers of what they drink and eat (unlike in other categories—for example, clothes, cars, and furniture—in which consumers can play a role in the appearance of the final product). Therefore, there is a need in the art for a label that allows a consumable supplier to forge a more personal relationship with its consumers.

### SUMMARY OF THE INVENTION

This need in the art is met by one aspect of the invention, in which a consumer personalizes a label for a product. The consumer performs the steps including inputting data into a workspace defined by software and obtaining a label comprising at least one of text and an image printed on a substrate. The software is adapted to generate personalized data comprising (a) at least one of text data and image data selected or created by the consumer and (b) location data that represent the location of the at least one of text data and image data in the workspace. The at least one of the text and image is printed in accordance with the personalized data.

In another aspect of the invention, an add-on label is provided. The add-on label is adapted for a product having at least one pre-printed indicium. The add-on label is superimposed over the pre-printed indicium and comprises print, including at least one of text and an image, and a window sized and positioned such that the indicium is visible through the window when the add-on label is superimposed on the product.

In yet another aspect of the invention, a method comprises providing a product for purchase by a consumer, providing a substrate with the product, and providing software. The substrate is adapted to be printed on to form a label for the product. The software can be used for designing the label, and is adapted to receive data in a workspace and generate personalized data comprising (a) at least one of text data and image data selected or created by a consumer and (b) location data that represent the location of the at least one of text data and image data.

### BRIEF DESCRIPTION OF THE DRAWINGS

FIG. 1 shows an exploded view of a personalized label according to an embodiment of the present invention and a product for use with the personalized label.

FIG. 2 shows a top view of a substrate according to an embodiment of the invention.

FIG. 3 shows a workstation for use with the invention.

FIG. 4 shows a flowchart according to a method of the invention.

### DETAILED DESCRIPTION OF THE PREFERRED EMBODIMENTS

The present invention relates to a personalized label 10 that individual consumers can create using software and a method for creating the personalized label. Personalized label 10 preferably comprises a substrate 12 made of a heat-shrinkable material, such as PVC, having text and/or graphics printed thereon, at least some of which a consumer selected or created.

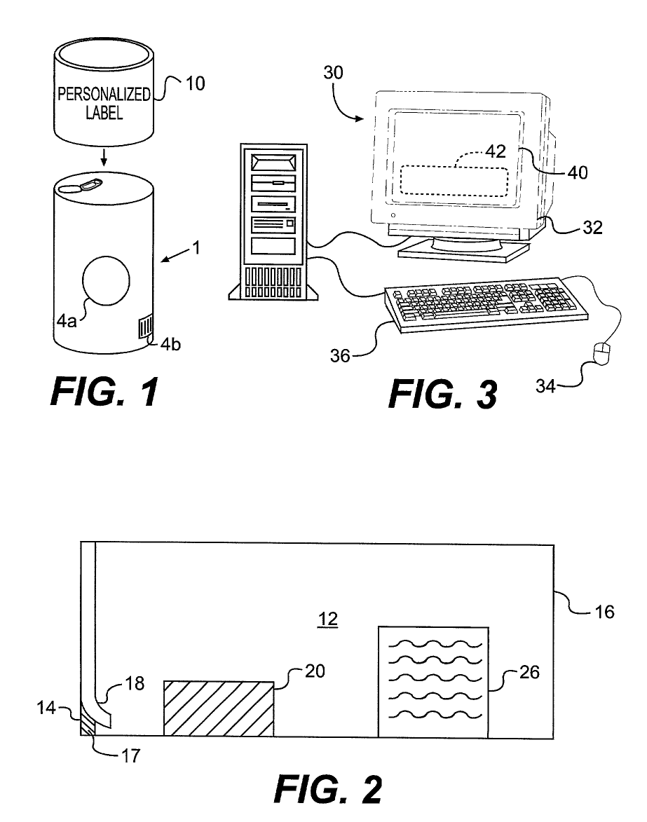

Referring to FIGS. 1 and 2, personalized label 10 is preferably in the form of a contiguous sleeve, so that it can be slipped over a product 1, such as a cylindrical 12 oz. can of soft drink, a 2 liter or other size bottle of soft drink, or other packaged products. Preferably, personalized label 10 is affixed to product 1 by application of heat. However, substrate 12 need not be heat-shrinkable, and personalized label 10 may be affixed to product 1 by adhesive or other means. Product 1 may have one or more pre-printed indicia 4a, 4b thereon—which may be formed on the product by known means, such as direct printing or attaching a label having pre-printed indicia 4a, 4b thereon—that personalized label 10 can obstruct. In this way, even products 1 with pre-printed indicia 4a, 4b can be personalized by placing personalized label 10 over pre-printed indicia 4a, 4b.

As shown in FIG. 2, substrate 12 is preferably made from a sheet of PVC approximately 2 mils in thickness. Ends 14, 16 of substrate 12 may be brought in contact with each other and bonded to form a contiguous, flexible sleeve that can readily take the shape of a cylinder or prism. A flat sheet is preferred as substrate 12 because such sheet will feed into a printer similarly to a sheet of paper. To facilitate forming a cylinder, substrate 12 may have adhesive 17 on at least one end 14. Adhesive 17 may be covered by a peel-off tape 18, which will prevent adhesive 17 from undesirably sticking to objects. When the consumer wishes to adhere ends 14, 16 of substrate 12 together, peel-off tape 18 can be removed, revealing underlying adhesive 17.

Of course, other means for securing ends 14, 16 of substrate 12 may be used, such as hot air hem sealing, hot wire sealing, hot knife sealing, supported hot wire sealing, hot melt adhesive, heated bar heat sealing, ultrasonic sealing, heated rollers or belts, adhesive film strips, infrared sealing, radio frequency sealing, or vibration welding.

Substrate 12 preferably comprises at least one printable region, which may be blank, that is, not pre-printed, and is suitable for personalization by a consumer. Preferably, the printable region is disposed on the side of the substrate 12 that ultimately will face product 1, so that a consumer's mouth will not come in contact with any ink that may be printed on the printable region. The printable region may be coated with a coating that facilitates ink absorption, which coating is preferably non-toxic. The printable region may be transparent or opaque, white or colored, but at any rate is preferably at least translucent and free from text or images. Any ink that is printed on the substrate 12 is preferably water-resistant and non-toxic.

Substrate 12 may consist entirely of the printable region, or it may have one or more regions not included in the printable region, such as pre-printed indicia 26. Pre-printed indicia 26 include, for example, the consumable supplier's name, trademark or logo, the product's name, trademark or logo, nutritional tables, or a Universal Product Code (UPC). Pre-printed indicia 26 may also comprise one or more themed indicia, such as an image of an athlete or a birthday image such as a birthday cake or candles.

Another region not included in the printable region includes at least one window 20, which is a transparent space through which at least part of underlying product 1, such as pre-printed indicia 4b on underlying product 1, is visible. Window 20 may be a transparent material or a cut-out portion of substrate 12. Pre-printed indicia 4b visible through window 20 may include, for example, nutritional tables, a UPC, or a consumable supplier's name, trademark or logo.

Consumers may obtain substrate 12 in a variety of ways. Substrate 12 may be provided with a package of product 1, such as a six-pack of soft drink cans or other product such as cans of soup, or substrate 12 may be provided with an individual product 1, such as a 2 liter bottle of soft drink or an individual can of soup. Alternatively, substrate 12 may be requested and sent in the mail. As a further alternative, substrate 12 may be provided at a kiosk or other particular location (hereinafter simply called a “kiosk”) in, for example, a supermarket, convenience store or other retail store. The kiosk preferably includes a computer having a monitor and input devices, and may further include a communication link, a printer and a heating device.

As previously mentioned, the consumer creates personalized label 10 using software. The software is preferably used in conjunction with a work station 30, such as a computer, having a monitor 32 and input devices, such as a mouse 34 and keyboard 36, as shown in FIG. 3. The software provides a plurality of design tools, which may be displayed on the monitor as icons or text menus. The design tools include clip art, text boxes, applications for importing external digital images such as scanned images and digital photographs, computer drawing tools for drawing shapes and lines, tools for cutting, cropping and pasting text and/or image data, and tools for manipulating data, such as by resizing or moving digital photographs. Of course, additional or alternative design tools used in any commercially-available word processor or graphic design program may be provided.

The software preferably allows the consumable supplier to control the content of text and/or images put on personalized label 10 by providing a menu of text and/or images, from which a consumer selects text and/or images. For example, the software may provide images of various athletes, images of cities, etc., as well as prepared slogans, such as slogans used in advertising product 1 or colloquialisms gathered from popular culture. The consumer can then mix-and-match the images and/or slogans as desired.

The software also preferably defines a workspace 40. Within workspace 40, the software may define a predetermined area 42, which may be depicted on computer monitor 32, and if depicted, may be shown as a box or other appropriate shape. Predetermined area 42 represents the part of substrate 12 suitable for printing personalized text and/or images, which are the physical text and/or images as printed on substrate 12.

Portions of substrate 12 may not be suitable for personalized text and/or images because those portions are reserved for one or more pre-printed indicia 26 or windows 20. Therefore, to prevent the user from placing personalized text and/or images in these locations on substrate 12, the locations in workspace 40 that correspond to these areas are excluded from predetermined area 42. In addition, predetermined area 42 is determined so that a user cannot place text and/or images outside of the boundaries of substrate 12.

One of ordinary skill will appreciate that predetermined area 42 does not need to be defined by the software. Rather, prohibited locations within workspace 40 may instead be stored, and the software may prompt the user with a warning or by preventing certain actions when the user attempts to place text and/or image data in a prohibited location.

The software instructs computer 30 to store the text and/or image data selected or created by the user, as well as the location of the text data and/or image data (i.e., location data) that the consumer input in workspace 40. The combination of text and/or image data and location data is the personalized data.

In a manner similar to substrate 12, consumers may obtain the software in a variety of ways. The software may be provided with product 1 on a computer readable medium, such as a CD or a floppy disk. Alternatively, the consumer may request and receive the software through the mail. As a further alternative, the software can be downloaded from a website. The consumer may also use the software without downloading or installing it by directly accessing the software at a website. The software may also be accessed at a computer at a kiosk in, for example, a retail store.

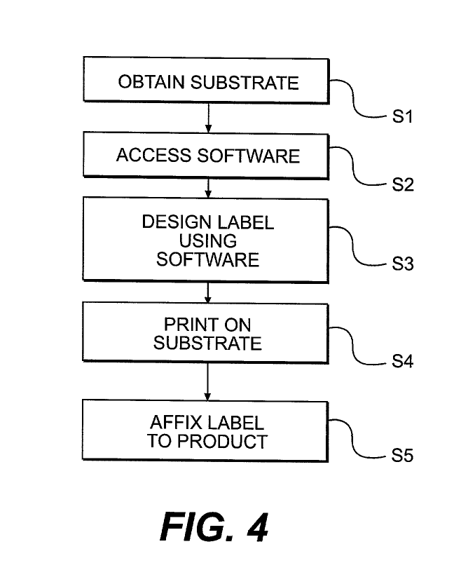

Methods for creating personalized label 10 will now be discussed. As shown in FIG. 4, a consumer creates personalized label 10 by obtaining a substrate 12 (S1), accessing software (S2), designing a label with the software (S3), and printing on the substrate 12 (S4) to form personalized label 10. Once personalized label 10 is thus created, the consumer, another individual, or a machine affixes personalized label 10 to product 1 (S5). These steps will be discussed in more detail below.

The first step in designing personalized label 10 is obtaining substrate 12 (S1). Substrate 12 may be provided with product 1, in which case the consumer simply removes substrate 12 from product 1. Alternatively, substrate 12 may be provided at a kiosk in a store in which product 1 is sold, such as a retail store. In another alternative, the consumer obtains substrate 12 and software through the mail.

The next step is accessing the software (S2). Software may be accessed by downloading it from the internet onto the consumer's computer. Of course, the software does not need to be downloaded, as a consumer may access the software by direct access through a website. The software may also be accessed through the consumer's personal computer by installing the software from a computer readable medium provided with product 1. The software may also be accessed through the computer provided at a kiosk.

Next, the consumer designs personalized data with the software (S3). The consumer may import, cut and paste, or otherwise insert personalized data, such as a digital photograph, clip art, and/or text, using the design tools provided with the software. The digital photographs and clip art may be obtained from the consumer's own files, or downloaded from a website. The design tools may permit modification of text and/or image data, such as resizing the data and moving the data. For example, the consumer may approach a kiosk with a floppy disk that stores a digital photograph taken by the consumer. The consumer can then copy the digital photograph from the disk and paste the photograph into workspace 40. The design tools are used to change the size of the photograph, insert text or clip art, or add or modify any other text and/or image data. In another example, to give the supplier more control over the final product, the consumer designs a label without any data he or she created, using only text and/or images provided with the software, such as prepared slogans and/or images.

After developing personalized data, substrate 12, which is preferably a sheet, is fed into a printer, which preferably contains non-toxic ink, to print personalized label 10 (S4). The printer preferably prints on the side of substrate 12 that will ultimately face product 1; as such, the printer preferably prints in reverse (i.e., a mirror image), allowing the printed text and/or image to be properly viewed through the substrate 12.

The printer may be local or remote. Local printing may be performed using a printer that is attached to the computer running the software, such as a computer at a kiosk or a consumer's personal computer.

In remote printing, substrate 12 is not immediately available to the consumer. As such, the first step (S1) is skipped by the consumer. The consumer merely sends personalized data generated with the software over a communication link to a third party who will print personalized label 10. The consumer may send the text and/or image data from a personal computer or a computer at a kiosk. The communication link, over which the text and/or image data are sent, may be a digital link, a modem and telephone line, radio, satellite, facsimile or such other communication links as are commercially available.

If the printing is performed remotely, the consumer may receive personalized label 10, which he or she designed, through the mail. Label 10 is preferably sent without product 1, but it is within the scope of the invention to send label 10 with product 1, including affixed to product 1 or shipped along with product 1. Alternatively, the consumer may be instructed to visit a particular location, such as a print shop, to pick up label 10. Preferably, label 10 is sent or made available to the consumer in the form of a sleeve, as shown in FIG. 1.

After printing, label 10 is affixed to product 1 (S5). Preferably, label 10 is already in the form of a sleeve so that label 10 is simply slipped over product 1 and affixed to product 1 by application of heat. If, however, label 10 is instead sent to the consumer in the form of a flat sheet, the label is first prepared to be affixed to product 1 by forming the label into a contiguous sleeve by bringing ends 14, 16 into contact with each other. Preferably this preparation is done with label 10 separated from product 1 to form the sleeve shown in FIG. 1, but it may also be done as label 10 is pressed against product 1. Then, as previously discussed, ends 14, 16 are secured by adhesive 17 or other means for securing. Label 10 is then preferably affixed to product 1 by the application of heat, such as by a blow dryer or other heater, causing heat-shrinkable substrate 12 to shrink around product 1.

Personalized label 10 may also be adhered directly to product 1, rather than heat-shrunk onto it. Adhesive may of course be used, but other means for affixing label 10 to product 1 include hot air hem sealing, hot wire sealing, hot knife sealing, supported hot wire sealing, hot melt adhesive, heated bar heat sealing, ultrasonic sealing, heated rollers or belts, adhesive film strips, infrared sealing, radio frequency sealing, and vibration welding.

In addition, the consumer's designs need not be used solely for forming a label 10. For example, the design can be printed on paper to be used for origami projects or paper airplanes.

One of ordinary skill will appreciate that consumers' designs can also be used for other non-printed purposes, such as screensavers, or e-mail to friends.

While the present invention has been described with respect to what are at present considered to be the preferred embodiments, it should be understood that the invention is not limited to the disclosed embodiments. To the contrary, as exemplified above, the invention is intended to cover various modifications and equivalent arrangements included within the spirit and scope of the appended claims. Therefore, the scope of the following claims is intended to be accorded the broadest reasonable interpretations so as to encompass all such modifications and equivalent structures and functions.

What is claimed is:

1. A method by which a consumer personalizes a label for a product, the consumer performing the steps comprising:
inputting data into a workspace defined by software, the software adapted to generate personalized data comprising (a) at least one of text data and image data selected or created by the consumer and (b) location data that represent the location of the at least one of text data and image data in the workspace; and
obtaining a label comprising at least one of text and an image printed on a substrate, the at least one of the text and image printed in accordance with the personalized data.

2. A method according to claim 1, wherein the product comprises a container of a beverage.

3. A method according to claim 1, wherein the obtaining step comprises sending the personalized data over a communication link.

4. A method according to claim 1, wherein the obtaining step comprises printing on the substrate locally.

5. A method according to claim 4, wherein the at least one of text and an image is printed on the substrate in reverse.

6. A method according to claim 1, wherein the software defines a predetermined area in the workspace, and the at least one of text data and image data are input into the predetermined area in the inputting step.

7. A method according to claim 1, wherein the software comprises design tools for modifying and moving the at least one of text data and image data, and the personalized data comprise the at least one of text data and image data as modified by the design tools.

8. A method according to claim 1, wherein the software comprises a menu including at least one of text and image data, and said inputting step comprises selecting the at least one of text and image data from the menu.

9. A method according to claim 1, wherein the image data comprise clip art.

10. A method according to claim 1, further comprising the step of affixing the personalized label to the product.

11. A method according to claim 10, wherein the affixing step comprises placing the label over the product and securing the label to the product.

12. A method according to claim 11, wherein the substrate comprises a heat shrinkable material, and the securing step comprises heat shrinking the label to the product.

13. An add-on label for a product having at least one pre-printed indicium, the add-on label superimposed over the pre-printed indicium and comprising:
print, including at least one of text and an image; and
a window sized and positioned such that the indicium is visible through the window when the add-on label is superimposed on the product.

14. An add-on label according to claim 13, wherein the product comprises a container of a beverage.

15. An add-on label according to claim 13, wherein a consumer designs the print using software adapted to generate personalized data comprising (a) at least one of text data and image data selected or created by a consumer and (b) location data that represent the location of the at least one of text data and image data.

16. An add-on label according to claim 13, wherein the print is printed by a consumer.

17. An add-on label according to claim 13, wherein the indicium comprises a UPC code.

18. An add-on label according to claim 13, wherein a view of at least part of the pre-printed indicium on the product is obstructed by the add-on label.

19. An add-on label according to claim 13, wherein the print is selected or created by a consumer.

20. An add-on label according to claim 13, wherein the print is printed in reverse.

21. A method comprising:
providing a product for purchase by a consumer;
providing a substrate with the product, the substrate being adapted to be printed on to form a label for the product; and
providing software that can be used for designing the label, the software adapted to receive data in a workspace and generate personalized data comprising (a) at least one of text data and image data selected or created by a consumer and (b) location data that represent the location of the at least one of text data and image data.

22. A method according to claim 21, wherein the product comprises a container of a beverage.

23. A method according to claim 21, wherein the substrate is heat-shrinkable.

24. A method according to claim 21, wherein the step of providing software comprises providing a kiosk including a computer with the software.

25. A method according to claim 24, wherein the kiosk further includes a printer that prints on the substrate in accordance with the personalized data.

26. A method according to claim 21, wherein the step of providing the substrate with the product comprises providing a kiosk in a store in which the product is sold, the kiosk being provided with a plurality of substrates.

27. A method according to claim 26, wherein the kiosk further includes a printer that prints on the substrate in accordance with the personalized data.

28. A method according to claim 27, wherein the printer prints on the substrate in reverse.

29. A method according to claim 21, wherein the step of providing software comprises providing the software with the product.

30. A method according to claim 21, wherein the software comprises a menu including at least one of text and image data.

31. A method according to claim 21, wherein the software comprises design tools for modifying and moving the at least one of text data and image data, and the personalized data comprise the at least one of text data and image data as modified by the design tools.

32. A method according to claim 21, wherein the image data comprise clip art.

33. A method according to claim 21, wherein the step of providing software comprises providing a website for at least one of downloading the software and accessing the software directly from the website.
